(19) United States
(12) Patent Application Publication
(10) Pub. No.: US 2014/0229576 A1
(43) Pub. Date: Aug. 14, 2014

(54) SYSTEM AND METHOD FOR BUFFERING STREAMING MEDIA UTILIZING DOUBLE BUFFERS

(71) Applicant: ALPINE AUDIO NOW, LLC, Reston, VA (US)

(72) Inventors: Marcel BARBULESCU, Falls Church, VA (US); Elan Joel BLUTINGER, Washington, DC (US)

(73) Assignee: ALPINE AUDIO NOW, LLC, Reston, VA (US)

(21) Appl. No.: 13/763,067

(22) Filed: Feb. 8, 2013

(51) Int. Cl. H04L 29/06

(52) U.S. Cl. CPC H04L 65/601
USPC 709/219

(57) ABSTRACT

Disclosed herein are systems, methods, and non-transitory computer-readable storage media for inserting messages in streaming media from a server to a client utilizing double buffers. A system streams a message to the client at an insertion point in the media. The message can be an advertisement specific to a client and can be based on client preferences, client behavior and physical location of the client. The system streams a set of compressed media segments from a compressed buffer storing a compressed version of media to the client based on a first pointer. The system streams a set of uncompressed media segments from an uncompressed buffer storing uncompressed media to the client based on a second pointer. The compressed media plays back at the client at an increased speed in relation to uncompressed media to compensate for time spent streaming the message to the client.

### BACKGROUND

1. Technical Field

The present disclosure relates to buffering streaming media and more specifically to message insertion in streaming media utilizing double source buffers.

2. Introduction

Streaming media is a process for continuously sending media segments over a telecommunications network, from one location to another. Usually a system streams media from a server to a client for consumption in the form of viewing, listening to or both, using a media player. The media stream is compressed prior to sending to a client and is decompressed at the client. The rate at which a client can receive media is limited to the data rate of the connection between the server and the client. Media is streamed using a unicast protocol which sends a separate copy of the stream from the server to each client, or using a multicast protocol which sends a single media stream to multiple users at the same time. An advantage of streaming media is that a user does not have to wait for an entire file to download before playing the file. The user is sent a continuous stream of data that plays back using a media player as it arrives at the client.

Many marketers utilize streaming media to advertise products targeted to specific groups of users, such as age, preferences and location. Traditionally, marketers would advertise to large groups of users through radio or broadcast television without the ability to target specific groups of users. When a client receives a unicast media stream, a separate copy of the stream is sent to each individual client from a server, allowing marketers to advertise products targeted to specific groups of users. A disadvantage of this method is that a server bears the burden of buffering, tracking and sending separate media streams to each individual client. Efficiently managing media streams on a server and tailoring advertisements to individual clients remains challenging.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for buffering streaming media utilizing double buffers from a server to a client. A system implementing the method streams a message to the client at an insertion point in the streaming media. The server determines the message insertion point and can base the insertion point on factors such as passage of time and natural pauses in the media. The message can be a targeted advertisement based on client preferences, client behaviors or physical location. The system streams a set of compressed media segments from a compressed buffer storing a compressed version of media to the client based at least on a first pointer, the first pointer being associated with the client. The system streams a set of uncompressed media segments from an uncompressed buffer storing uncompressed media to the client based at least on a second pointer, the second pointer being associated with the client. Optionally, the system streams a set of uncompressed media segments from the uncompressed buffer to the client prior to streaming the message to the client. Maintaining a separate compressed buffer enables a server to insert a message in a media stream and compensate for the time it spent buffering the message to the client. At the client, the set of compressed media segments play back at an increased speed relative to the uncompressed media segments that is undetectable.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example buffering system embodiment;

FIG. 2 illustrates buffering streaming media utilizing multiple buffers;

FIG. 3 illustrates buffering streaming media utilizing a single buffer;

FIG. 4 illustrates buffering streaming media utilizing double buffers;

FIG. 5 illustrates an example method embodiment; and

FIG. 6 illustrates an example double buffering system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

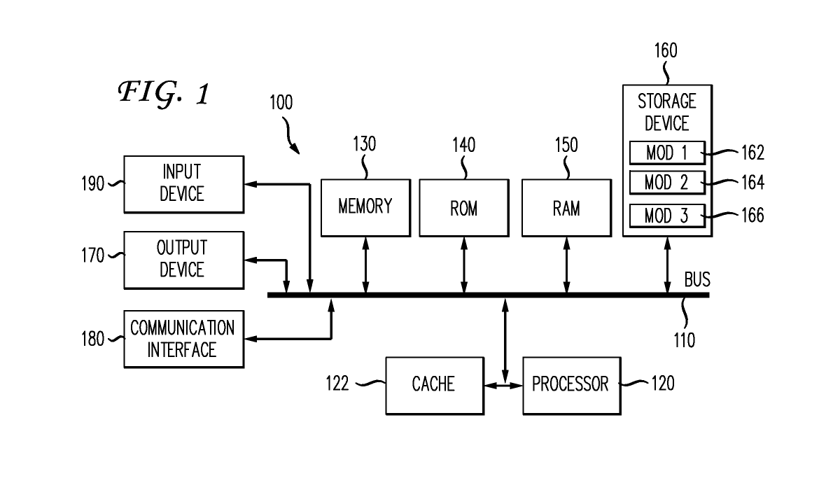

The present disclosure addresses the need in the art for buffering streaming media utilizing double buffers. A system, method and non-transitory computer-readable media are disclosed which buffer streaming media utilizing double source buffers. A brief introductory description of a basic general purpose system or computing device in FIG. 1 which can be employed to practice the concepts is disclosed herein. A more detailed description of buffering streaming media utilizing double buffers will then follow.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

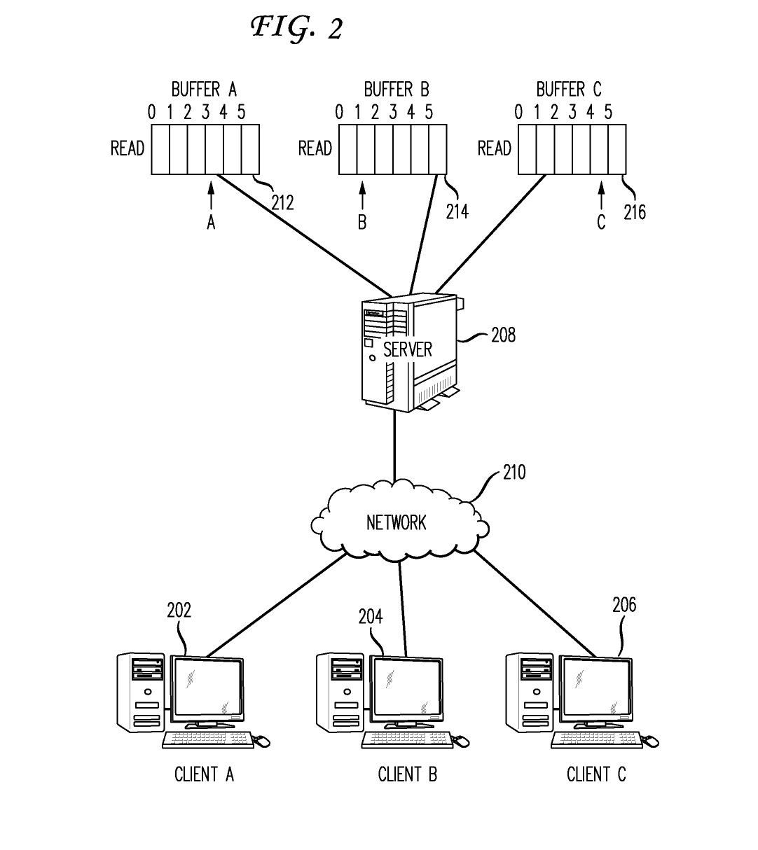

Having disclosed some components of a computing system, the disclosure now turns to FIG. 2, which illustrates buffering streaming media utilizing multiple buffers for multiple clients. Many marketers insert advertisements, commercials or political messages in streaming media aimed at large audiences, similar to the way marketers insert advertisements in radio or broadcast television. A straight forward approach to inserting a message or advertisement specific to each client is for a server to keep a separate streaming media buffer for each client, because different messages will play at different moments of time for each client. Because clients connect to the server at different times, and clients have differing preferences, behaviors and physical location, different advertisements or messages can be played at different times for each client. Multiple clients can simultaneously connect to a server and receive streaming media with messages or advertisements intended for each individual client inserted in each media stream. For example, clients A 202, B 204 and C 206 connect to a server 208 through a network 210 at different times. The server creates a respective buffer for each client; buffer A 212, buffer B 214 and buffer C 216. Because a server streams media in consecutive segments, a pointer is utilized to mark the next segment of media a client receives. When the server 208 determines a message insertion point for a specific client, the server can stop streaming media from the buffer to the client, stream a message to the client, and then resume streaming media from the buffer to the client. For example, if client A 202 connects at 10:01 PM the server 208 can create a buffer for client A 212 and being streaming media to client A. The server can utilize a pointer storing a memory location of the next media segment to stream to the client. The server 208 can determine an appropriate message insertion point for example at 10:09 PM, stop the media stream and stream a message to the client at 10:09 PM. After the server 208 streams a message, the server 208 can then resume streaming from buffer A 212. If client B 214 connects at 10:04 PM the server 208 can determine an appropriate message insertion point in the stream for example at 10:10 PM and can deliver a message targeted to the client 214 at 10:10 PM. Although this straight-forward approach buffers media for users individually and can deliver targeted messages to users, it is inefficient because the server must maintain a separate buffer for each user.

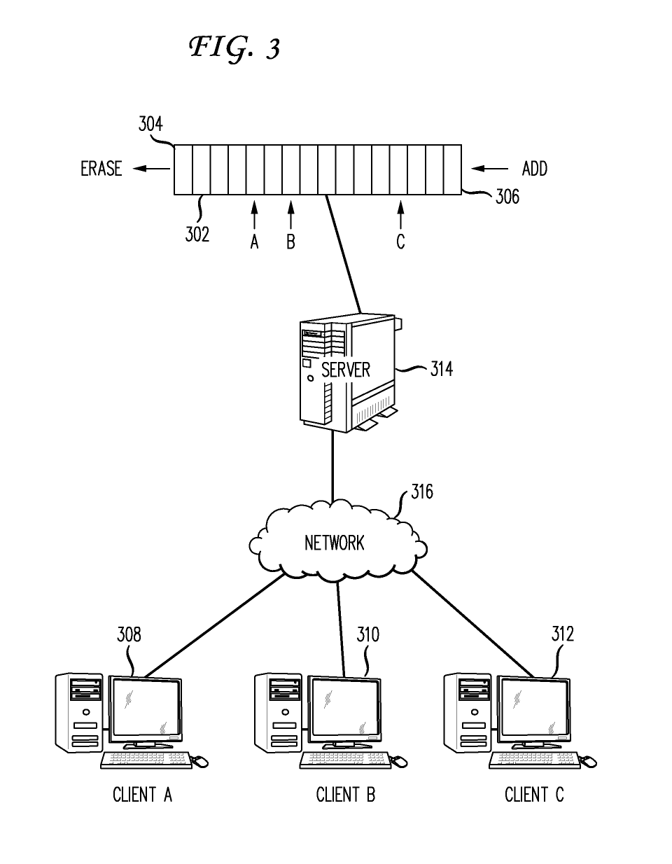

An alternate and more efficient approach to creating and maintaining buffers for different clients is to create one buffer at a server and use pointers to track each client's location within the buffer. The buffer can be considered a “sliding” buffer because media is erased from one end and new media added to the other end of the buffer. FIG. 3 illustrates buffering streaming media utilizing a single media buffer for all clients. For example, a buffer 302 can hold one minute of audio and each second it erases one second of audio from an end of the buffer 304 and adds one second of audio to the other end 306. Clients A 308, B 310 and C 312 connect to a server 314 through a network 316 and each are assigned a respective pointer tracking a next media segment in the buffer. The location of each client's pointer differs because it depends on when a client connects, and when a client requests a certain amount of media. When a client requests more audio than the server buffers from the source, the server will ask the client to wait. If a client lags too much and does not request audio within the one minute buffer, the server disconnects from the client because the audio stream will not be continuous at the client. When the server 314 determines a message insertion point in a stream for a client, the server 314 can stop streaming audio from the buffer 302 and stream a message. Then the server picks up streaming where it left off in the buffer, utilizing the client's pointer into the buffer that marks the next segment to stream. A problem with this method is that a client lags more each time a message is streamed to the client. At some point, the server 314 will disconnect the client because the client is not within the one minute buffer.

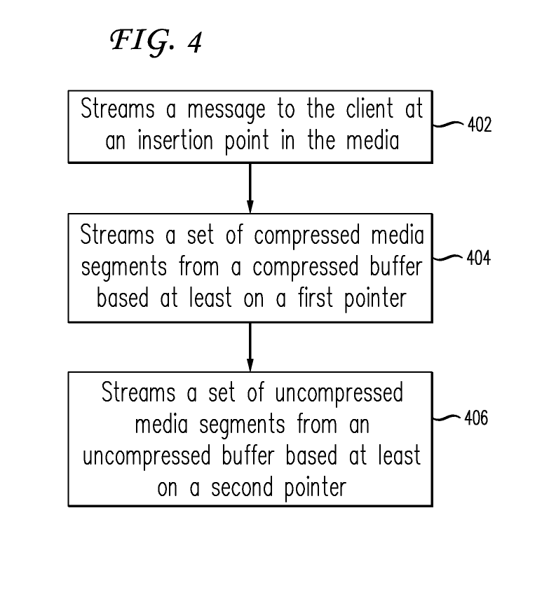

Having disclosed some basic system components and concepts, the disclosure now turns to the exemplary method embodiment shown in FIG. 4. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

FIG. 4 illustrates buffering streaming media utilizing double buffers. The streaming media can be audio, video or multimedia containing both audio and video. A system practicing the method utilizes two buffers, a compressed buffer storing compressed media segments and an uncompressed buffer storing uncompressed media segments. A client connects to a server through a telephone connection and requests streaming media from the server. Streaming media from a server is not limited by the number of buffers a server can maintain, but rather the number of clients that can connect to it. Many clients can connect to the server and receive streaming media concurrently.

The system streams a message to a client at an insertion point in the media (402). A server determines the insertion point based on client preferences such as music genre, client behaviors such as typical time of day a client connects and client physical location based on a phone number or other location information. The insertion point can be based on other factors such as time passed since a client connected to the server for example within the first five minutes, ten minutes or twenty minutes. The message can be any message or advertisement intended for a specific audience such as political, religious or commercial. Next, the server streams a set of compressed media segments from a compressed buffer storing a compressed version of media to the client based at least on a first pointer associated with the client (404). The server updates the first pointer after sending the each compressed media segment such that the first pointer stores the memory location of a next media segment in a set to stream to the client. The server streams a compressed version of media segments from the compressed buffer to compensate for the time that sending the message consumed. After the server runs out of compressed media segments to stream to the client from the compressed buffer, it streams a set of uncompressed media segments from an uncompressed buffer storing uncompressed media to the client based at least on a second pointer associated with the client (406). The server updates the second pointer after sending each uncompressed media segment such that the second pointer stores the memory location of a next media segment in a set to stream to the client.

The size and number of media segments a server streams to a client is based on how much media the client requests and when the server inserts the message in the media stream. The process of sending sets of compressed media segments and uncompressed media segments repeats at another message insertion point in the stream determined by the server at a later time. An advantage of the disclosed method is that clients are not dropped due to lag and a server can insert messages or advertisements specific to each user instead of sending messages or advertisements to large audiences that may or may not appeal to each client. Each client can receive messages that have a greater chance of appealing to the client because messages are based on factors such as client preferences, client behaviors and client location.

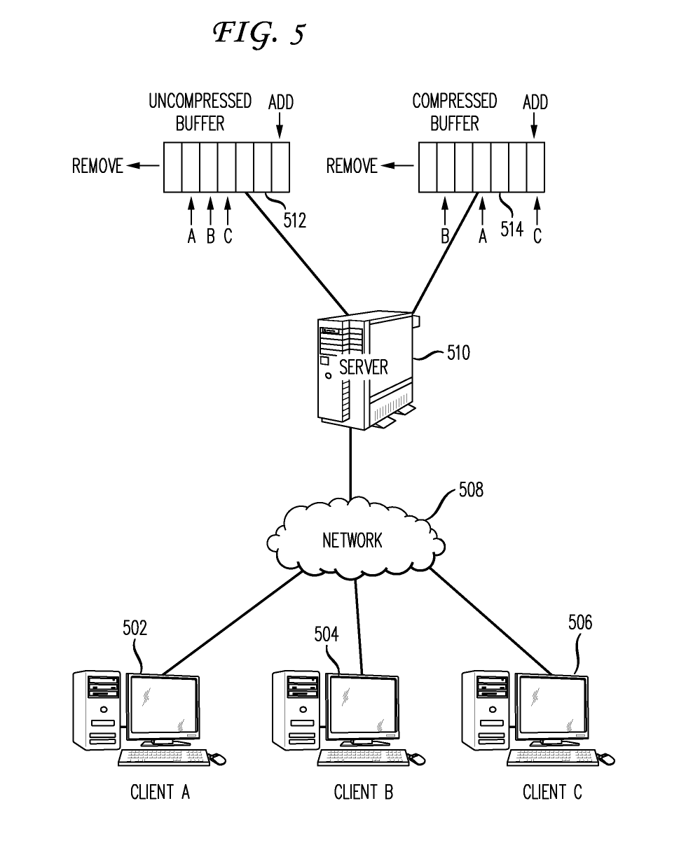

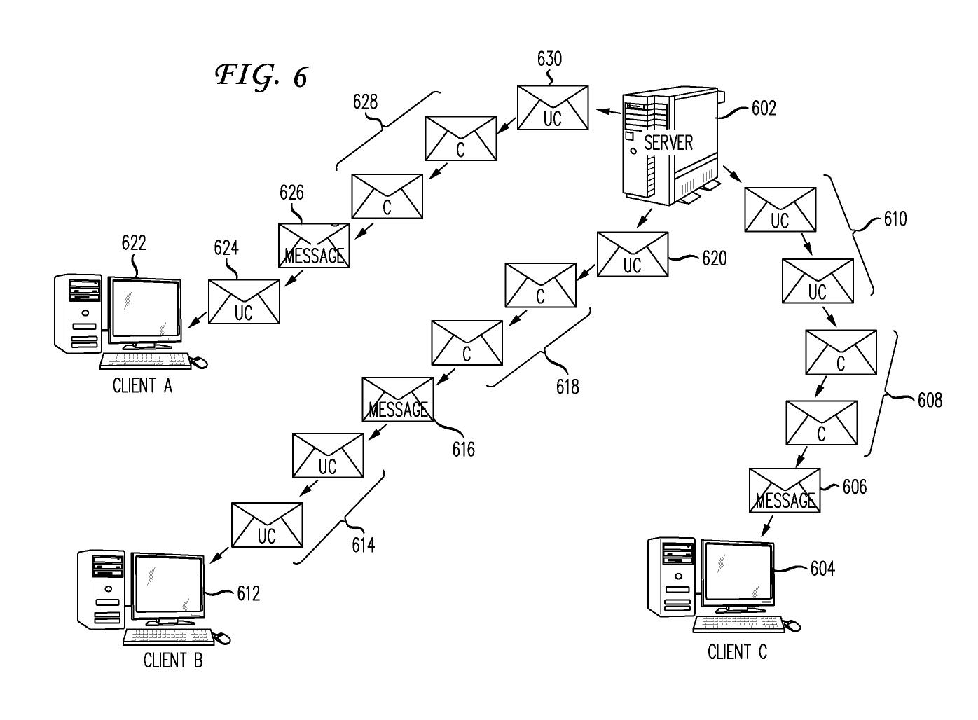

FIG. 5 and FIG. 6 illustrate buffering streaming media utilizing double buffers. For example, Clients A 502, B 504 and C 506 connect to a server 510 at different times through a telephone connection 508 and each are assigned a respective pointer marking the location of a next compressed media segment in the compressed buffer 512. The server 510 can determine a message insertion point for each client such as at the beginning of streaming media or ten minutes after a client connects to the server 510. The server 510 can determine a message insertion point for client A at two minutes into streaming media, five minutes into streaming media for client B and prior to streaming media for client C.

When a message insertion point is at the beginning of streaming media, the server 602 can stream a message to the client prior to starting streaming media from a buffer. Client C 604 can receive an advertisement 606 prior to receiving streaming media from a buffer and can receive compressed media segments 608 after receiving the advertisement until it reaches the end of the compressed buffer. Once client C has received all of the segments in the compressed media buffer 512, the server sends segments from the uncompressed media buffer 514, 610.

Alternately, when a message insertion point is during streaming media, the server 602 can stream a set of uncompressed media segments from the uncompressed buffer 512 using a pointer to mark the next media segment. At the message insertion point, the server can stop streaming from the uncompressed buffer and stream the message to the client. Next, the server can resume streaming; however the server streams compressed media segments from a compressed buffer 514 storing a compressed version of media to the client using a pointer to mark the next media segment. The server streams compressed media segments until it reaches the end of the compressed buffer; the server has caught the client up to the uncompressed buffer. When the server reaches the end of the compressed buffer, it has compensated for the time spent streaming a message to a client. At this point, the server reverts back to sending uncompressed media segments from the uncompressed buffer.

For example, client B 612 connects to the server 602 and requests streaming media. The server streams uncompressed media segments 614 from the uncompressed media buffer 514. The server determines a message insertion point, stops streaming from the uncompressed media buffer 514 and streams a political message to the client 616. Next, the server streams compressed media segments 618 from the compressed buffer 512 to the client 610. Once all of the compressed media segments 618 have been streamed to the client, the server 602 reverts back to streaming uncompressed media segments 620 to the client from the uncompressed media buffer 514.

Additionally, a server 602 can stream a message to a client shortly after a client connects to the server 602. For example, client A 622 connects to the server 602 and requests streaming media. The server 602 streams an uncompressed media segment 624 to the client 622 before streaming an advertisement 626 to the client 620. After the server 602 streams the advertisement 626, the server streams compressed media segments 628 to the client 622 until the server reaches the end of the compressed media buffer. At this time, the server reverts back to streaming uncompressed media segments 630 to the client 620. In this way, the server can efficiently insert messages in streaming media utilizing double buffers instead of maintaining a separate buffer for each user or dropping users due to lag attributed to message insertion. Instead of a server maintaining a separate media buffer for each client, the server can simply maintain a set of pointers containing a first pointer and a second pointer that store memory locations to respective compressed and uncompressed media buffers.

At a client, a received compressed media stream plays back at an increased rate in relation to a received uncompressed media stream that is undetectable to humans. The server can determine a rate to speed up the media such as 5% that would go undetected by a client. Because the compressed media is faster, the compressed buffer is 5% smaller in terms of data than the uncompressed buffer. The rate at which data is added to the compressed buffer is slower than the rate at which data is added to the uncompressed buffer. If a client is consuming media at the same rate as the server is buffering media, the pointer in the compressed (and faster) buffer will move closer towards the beginning of the buffer where new media is added until the server has sent all of the compressed media it stores at a particular time to the client. At this point, the server reverts back to streaming uncompressed media segments to the client.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of inserting messages in streaming media to a client from a server, the method comprising:
streaming a message to the client at an insertion point in the media;
streaming a set of compressed media segments from a compressed buffer storing a compressed version of media to the client based at least on a first pointer, the first pointer being associated with the client; and
streaming a set of uncompressed media segments from an uncompressed buffer storing uncompressed media to the client based at least on a second pointer, the second pointer being associated with the client.

2. The method of claim 1, wherein the streaming media is streaming audio.

3. The method of claim 1, wherein the client communicates with the server via a telephone connection.

4. The method of claim 1, wherein the first pointer indicates the starting address of a segment in the set of compressed media segments.

5. The method of claim 4, wherein the server updates the first pointer after an uncompressed media segment is streamed to the client.

6. The method of claim 1, wherein the second pointer indicates the starting address of a segment in the set of uncompressed media segments.

7. The method of claim 6, wherein the server updates the second pointer after a compressed media segment is streamed to the client.

8. The method of claim 1, wherein the server streams compressed media segments until all compressed media segments have been streamed.

9. The method of claim 1, wherein the compressed media plays back at the client at an increased speed.

10. The method of claim 1, wherein any number of clients connects to and receives streaming media from the server concurrently.

11. The method of claim 1, wherein the message is a targeted advertisement.

12. The method of claim 11, wherein the targeted advertisement is based on at least one of client preferences, client behaviors and client physical location.

13. The method of claim 1, wherein the number of media segments in a set is based on at least one of the amount of data the client requests and when the server inserts the advertisement.

14. The method of claim 1, wherein the size of media segments in a set is based on at least one of the amount of data the client requests and when the server inserts the advertisement.

15. A system for locating an advertisement insertion point, the system comprising:
a processor;
a memory storing instructions for controlling the processor to perform steps comprising:
streaming a message to the client at an insertion point in the media;
streaming a set of compressed media segments from a compressed buffer storing a compressed version of media to the client based at least on a first pointer, the first pointer being associated with the client; and
streaming a set of uncompressed media segments from an uncompressed buffer storing uncompressed media to the client based at least on a second pointer, the second pointer being associated with the client.

16. The system of claim 15, wherein the compressed media plays back at the client at an increased speed.

17. The system of claim 15, wherein any number of clients connects to and receives streaming media from the server concurrently.

18. A non-transitory computer-readable storage medium storing instructions which, when executed by a computing device, cause the computing device to perform steps comprising:
streaming a message to the client at an insertion point in the media;
streaming a set of compressed media segments from a compressed buffer storing a compressed version of media to the client based at least on a first pointer, the first pointer being associated with the client; and
streaming a set of uncompressed media segments from an uncompressed buffer storing uncompressed media to the client based at least on a second pointer, the second pointer being associated with the client.

19. The non-transitory computer-readable storage medium of claim 18, wherein the message is a targeted advertisement.

20. The non-transitory computer-readable storage medium of claim 19, wherein the targeted advertisement is based on at least one of client preferences, client behaviors and client physical location.
